(19) United States
(12) Patent Application Publication
(10) Pub. No.: US 2025/0034363 A1
(43) Pub. Date: Jan. 30, 2025

(54) SIZING AGENT COMPOSITION, SIZING AGENT, CARBON FIBER COVERED WITH SIZING AGENT, AND COMPOSITE MATERIAL

(71) Applicant: FORMOSA PLASTICS CORPORATION, Kaohsiung City (TW)

(72) Inventors: Hsuan-Yin CHEN, Kaohsiung City (TW); Long-Tyan HWANG, Kaohsiung City (TW); Chien-Hsin WU, Taipei City (TW); Ying-Chi HUANG, Taipei City (TW); Chien-Jung WANG, Taipei City (TW); Shih-Huang TUNG, Taipei City (TW); Ru-Jong JENG, Taipei City (TW)

(21) Appl. No.: 18/750,430

(22) Filed: Jun. 21, 2024

(30) Foreign Application Priority Data
Jul. 25, 2023 (TW) 112127846

(51) Int. Cl. C08K 9/04; D01F 11/14

(52) U.S. Cl. CPC C08K 9/04; D01F 11/14; D10B 2101/12

(57) ABSTRACT

The present invention relates to a sizing agent composition, a sizing agent, a carbon fiber covered with the sizing agent, and a composite material. The sizing agent composition includes a polyamic acid and an alkali agent. The alkali agent has a specific molecular weight, and there is a specific molar ratio between the polyamic acid and the alkali agent, such that emulsification stability of the polyamic acid and thermal stability of a sizing layer consisting of the sizing agent are enhanced, thereby increasing interlayer bonding strength in the composite material that is made by the carbon fiber covered with the sizing agent.

### CROSS-REFERENCE TO RELATED APPLICATION

This application claims priority to Taiwan Application Serial Number 112127846, filed Jul. 25, 2023, which is herein incorporated by reference in its entirety.

### BACKGROUND

### Field of Invention

The present invention relates to a sizing agent composition, a sizing agent, a carbon fiber covered with the sizing agent, and a composite material. More particularly, the present invention relates to a sizing agent composition including polyamic acid and an alkali agent, a sizing agent, a carbon fiber covered with the sizing agent, and a composite material.

### Description of Related Art

The composite material possesses superior strength while still maintaining good impact resistance, chemical resistance, and heat resistance even when weight reduction is applied. The reinforcing material in the composite material includes carbon fibers. After bonding with the resin matrix, carbon fibers form carbon fiber composite materials.

However, carbon fibers have low elongation and are prone to brittleness, leading to the generation of fuzz and/or broken fibers during processing. Fuzz and broken fibers reduce the resin matrix's impregnation of the carbon fibers, thereby decreasing the interlayer bonding strength of the resulting composite material. Therefore, carbon fibers covered with the sizing agent can enhance impregnation of the carbon fibers in the resin matrix.

Numerous modifiers are often added into the conventional sizing agent composition for improving impregnation. However, this approach also gives rise to other problems, such as reducing the thermal stability of the sizing layer formed by the sizing agent. In addition, during high-temperature processing of the carbon fibers covered with the sizing agent, thermal decomposition of the sizing agent composition or chemical restructuring of the sizing agent occurs, further reducing the resin matrix's impregnation of the carbon fibers and consequently lowering the interlayer bonding strength of the composite material.

In view of these challenges, there is an urgent need to develop a new sizing agent composition, sizing agent, carbon fibers covered with the sizing agent, and composite materials to address the above-mentioned drawbacks of conventional products.

### SUMMARY

Therefore, one aspect of the present invention provides a sizing agent composition. The sizing agent composition includes polyamic acid and an alkali agent. The alkali agent has a specific molecular weight, and there is a specific molar ratio between the polyamic acid and the alkali agent, so as to enhance the emulsification stability of polyamic acid and the thermal stability of the sizing layer consisting of the sizing agent composition.

Another aspect of the present invention provides a sizing agent including the aforementioned sizing agent composition. A complex formed from polyamic acid and the alkali agent can enhance the emulsification stability of polyamic acid, as well as the thermal stability of the sizing layer consisting of the sizing agent composition.

Yet another aspect of the present invention provides a carbon fiber covered with the sizing agent comprising a sizing layer consisting of the aforementioned sizing agent composition to enhance the interlayer bonding strength of the composite material produced from the carbon fiber covered with the sizing agent.

Still another aspect of the present invention provides a composite material including the aforementioned carbon fiber covered with the sizing agent to enhance the interlayer bonding strength of the composite material.

According to one embodiment of the present invention, a sizing agent composition is provided. The sizing agent composition comprises polyamic acid, the alkali agent, and a solvent. The alkali agent has a molecular weight greater than 31 g/mol and less than 170 g/mol, and the molar ratio between polyamic acid and the alkali agent is from 0.01 to 0.2. Based on 100 weight percent of polyamic acid, the alkali agent is used in an amount of 3 weight percent to 30 weight percent.

In one embodiment of the present invention, the molecular weight of polyamic acid can be 5000 g/mol to 30000 g/mol.

In another embodiment of the present invention, the alkali agent is selected from the group consisting of organic amine compounds, salts of organic amine compounds, ammonia solution, alkali metal bicarbonates, and combinations thereof.

In yet another embodiment of the present invention, the organic amine compound is a tertiary amine compound having 3 to 9 carbon atoms.

According to an another embodiment, the polyamic acid has the following chemical structure represented by formula (I):

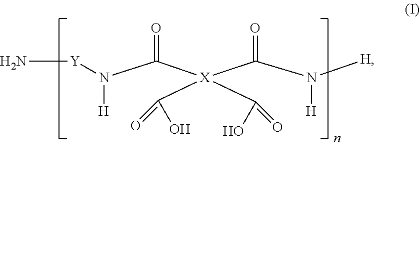

in the formula (I), X represents a tetravalent group having the chemical structures shown in formulas (I-1-1) to (I-1-5), Y represents a divalent group having the chemical structures shown in formulas (I-2-1) to (I-2-4), and n is an integer from 7 to 62;

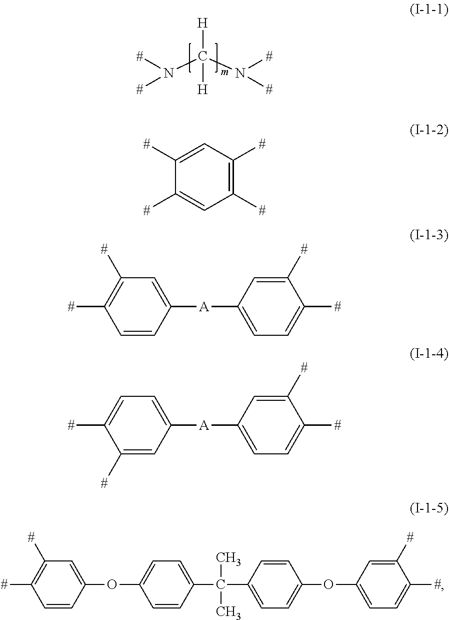

in the formulas (I-1-1) to (I-1-5), these symbols # represent the position where X is bonded to the carbon atom of the amide or carboxyl group shown in the formula (I); in the formula (I-1-1), m represents an integer of 1 to 4; in the formulas (I-1-3) to (I-1-4), A represents a bond, ether group, ketone group or sulfone group;

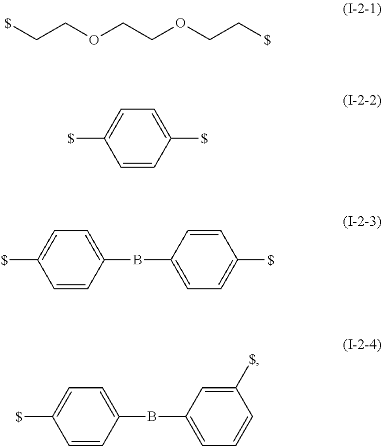

in the formulas (I-2-1) to (I-2-4), these symbols $ represent the position where Y is bonded to the nitrogen atom of the amide or amine group shown in the formula (I). In the formulas (I-2-3) to (I-2-4), B represents an alkylene group, an ether group, a thioether group or a sulfone group with 1 to 3 carbon atoms.

In another embodiment of the present invention, the molar ratio between polyamic acid and the alkali agent can be 0.02 to 0.15.

Another embodiment of the present invention provides a sizing agent including the aforementioned sizing agent composition.

Yet another embodiment of the present invention provides a carbon fiber covered with the sizing agent. The carbon fiber covered with the sizing agent include carbon fibers and a sizing layer covering the carbon fiber. The sizing layer consists of the aforementioned sizing agent composition, and the sizing layer exhibits a thermal weight loss of less than 1 weight percent after being subjected to 300° C. for 30 minutes.

Yet another embodiment of the present invention provides a composite material comprising a resin matrix and a carbon fiber covered with the sizing agent dispersed within the resin matrix.

In one embodiment of the present invention, the resin matrix includes polyphenylene sulfide, polyamide, and/or polyether ether ketone.

The application of the sizing agent composition, the sizing agent, the carbon fiber covered with the sizing agent, and the composite material of the present invention, in which the sizing agent composition that includes polyamic acid and an alkali agent, in which the alkali agent has a specific molecular weight and a specific molar ratio with polyamic acid, can enhance the emulsification stability of polyamic acid and the thermal stability of the sizing layer formed from the sizing agent composition, thereby strengthening the interlayer bonding strength of the composite material produced from carbon fiber covered with the sizing agent.

These and other features, aspects, and advantages of the present invention will become better understood with reference to the following description and appended claims.

It is to be understood that both the foregoing general description and the following detailed description are by examples, and are intended to provide further explanation of the invention as claimed.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

The following discussion elaborates on the manufacturing and use of exemplary embodiments of the present invention. However, it can be understood that the embodiments provide many inventive concepts that can be applied to various specific contexts. The specific embodiments discussed are for illustration purposes only and are not intended to limit the scope of the invention.

The sizing agent composition of the present invention comprises polyamic acid, an alkali agent, and a solvent. Based on 100 weight percent of polyamic acid, the alkali agent is used in an amount of 3 weight percent to 30 weight percent. If the amounts of polyamic acid and the alkali agent were beyond the aforementioned range, the emulsion stability of the sizing agent would be poor, the coverage of the sizing agent on the carbon fiber would be insufficient, and it could even reduce the thermal stability of the sizing layer formed from this sizing agent. There is no specific limitation on the amount of solvent, but it aims to provide polyamic acid with good emulsification stability (e.g., the particle size of the sizing agent is less than 600 nm and its mobility is less than 30% per hour). For example, the amount of solvent can optionally be 70 to 90 times the total amount of polyamic acid and the alkali agent (by weight). In some embodiments, the solvent can be water and/or organic solvent. Organic solvents can be those commonly used for synthesizing polyamic acid or known organic solvents.

Polyamic acid can be synthesized from dianhydrides and diamines. Specifically, a polyamic acid molecule can have two carboxyl groups, which can form complexes with the alkali agent. In some embodiments, the dianhydride can optionally include aliphatic dianhydrides and aromatic dianhydrides, and the diamine can optionally include aliphatic diamines and aromatic diamines.

For example, specific examples of dianhydrides can include pyromellitic dianhydride (PMDA), benzophenonetetracarboxylic dianhydride (BTDA), 4,4′-oxydiphthalic anhydride (ODPA), 3,3′,4,4′-benzophenonetetracarboxylic dianhydride (BTDA), 3,3,4,4′-diphenylsulfone tetracarboxylic dianhydride (DSDA), 2,3,3′,4′-biphenyltetracarboxylic dianhydride (α-BPDA), 4,4′-(4,4′-isopropylidenediphenyloxy) diphthalic anhydride (BPADA), and ethylenediaminetetraacetic dianhydride (EDTAD). Specific examples of diamines can include hexamethylenediamine (HDA), 2,2′-(ethylenedioxy) diethylamine (EDA), 4,4′-diaminodiphenyl ether (4,4′-ODA), 3,4′-diaminodiphenyl ether (3,4′-ODA), 4,4′-diaminodiphenyl sulfide, 4,4′-diaminodiphenylmethane, paraphenylenediamine (p-PDA), 3,3′-diaminodiphenylsulfone, and 4,4′-diaminodiphenylsulfone.

Solvents for synthesizing g polyamic acid can include N,N-dimethylformamide (DMF), N,N-dimethylacetamide (DMAc), N-methylpyrrolidone (NMP), and combinations thereof. These solvents are exemplary and not limited to them.

In some embodiments, the amount of diamine can optionally be 0.7 to 1.3 times the amount of dianhydride (in moles) to increase the yield of polyamic acid with two carboxyl groups (to at least 95%) and reduce unreacted diamine and dianhydride, thereby facilitating the formation of complexes between the carboxyl groups of polyamic acid and the amino groups of the alkali agent.

For example, the polyamic acid can optionally have the structure shown in the formula (I) rather than being limited hereinafter:

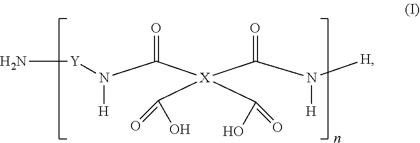

in the formula (I), X represents a tetravalent group having the chemical structure shown in the formulas (I-1-1) to (I-1-5), Y represents a divalent group having the chemical structure shown in the formulas (I-2-1) to (I-2-4), and n represents an integer of 7 to 62;

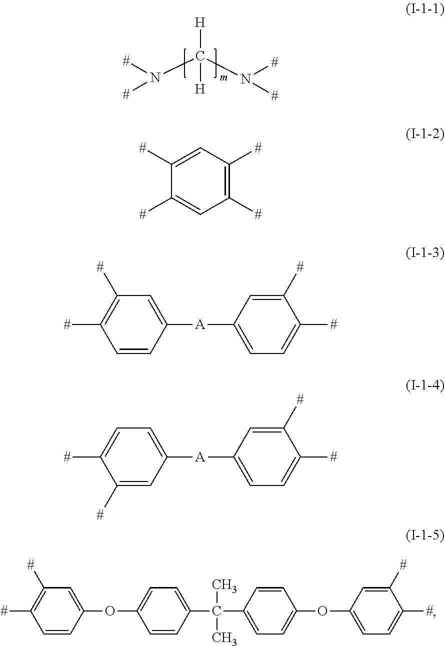

in the formulas (I-1-1) to (I-1-5), these symbols # represent the position where X is bonded to the carbon atom of the amide or carboxyl group shown in the formula (I); in the formula (I-1-1), m represents an integer of 1 to 4; in the formulas (I-1-3) to (I-1-4), A represents a bond (e.g., a covalent bond, an ionic bond, a hydrogen bond, and a hydrophobic bond), ether group, ketone group or sulfone group;

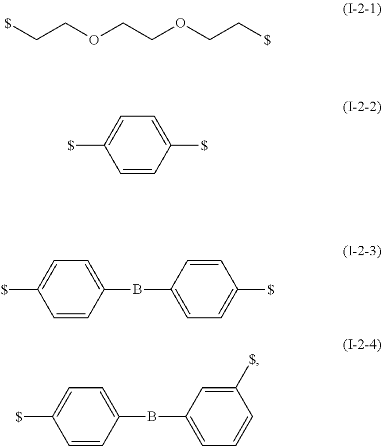

in the formulas (I-2-1) to (I-2-4), these symbols $ represent the position where Y is bonded to the nitrogen atom of the amide or amine group shown in the formula (I). In the formulas (I-2-3) to (I-2-4), B represents an alkylene group, an ether group, a thioether group or a sulfone group with 1 to 3 carbon atoms.

When X represents the aforementioned tetravalent group, Y represents the aforementioned divalent group, and n represents the aforementioned integer, it allows the polyamic acid to exhibit good self-emulsification properties, leading to excellent emulsification stability of the polyamic acid, thereby enhancing the thermal stability of the sizing layer formed from the sizing agent composition.

In addition, in some embodiments, the molecular weight of polyamic acid can optionally be 5000 g/mol to 30000 g/mol, with preferable 7500 g/mol to 25000 g/mol, to further enhance the thermal stability of the sizing layer formed from the sizing agent composition.

In some embodiments, the alkali agent is selected from the group consisting of organic amine compounds, salts of organic amine compounds, ammonia solution, alkali metal bicarbonates, and combinations thereof. The alkali agent has a molecular weight greater than 31 g/mol and less than 170 g/mol. If the molecular weight of the alkali agent exceeded the aforementioned range, the carboxyl groups of polyamic acid would hardly form stable complexes with the amino groups, ammonium ions, or metal ions of the alkali agent, resulting in reducing the emulsification stability of the polyamic acid and/or the thermal stability of the sizing layer formed from the sizing agent composition.

In some specific examples, the alkali agent can be an organic amine compound and/or salts of organic amine compounds. The preferred organic amine compounds typically have a molecular weight greater than 31 g/mol and less than 150 g/mol. Generally, these organic amine compounds can have a pKb of 1.5 to 9.5. For instance, the pKb of ammonia solution is approximately 4.7, while other amines typically have pKb values of about 2 to about 3, and pyridine has a pKb of approximately 8.8. In other specific examples, the organic amine compounds can optionally be tertiary amine compounds with a carbon number of 3 to 9. This increases the strength and stability of the hydrogen bonds formed between the carboxyl groups of polyamic acid and the amine groups of organic amine compounds, thereby further enhancing the thermal stability of the sizing layer formed from the sizing agent composition. Moreover, specific examples of organic amine compounds can include trimethylamine (molecular weight of 59.11 g/mol), triethylamine (molecular weight of 101.19 g/mol), tri-n-propylamine (molecular weight of 143.27 g/mol), 1,8-diazabicyclo [5.4.0]undec-7-ene (molecular weight of 152.24 g/mol), and combinations thereof. Examples of salts of organic amine compounds can include hydrochloride, nitrate, acetate, and combinations thereof.

In other specific examples, the alkali agent can be ammonia solution. The ammonium ions from ammonia solution can form stable complexes with the carboxyl groups of polyamic acid. In yet other specific examples, the alkali agent can be alkali metal bicarbonate. The alkali metal bicarbonates can optionally include sodium bicarbonate, potassium bicarbonate or any combination thereof. The metal ions from alkali metals can form stable complexes with the carboxyl groups of polyamic acid.

As aforementioned, the molar ratio of polyamic acid to the alkali agent can be from 0.01 to 0.2, preferably from 0.02 to 0.15. If the molar ratio of polyamic acid to the alkali agent was beyond the aforementioned range, in the case of excess alkali agent (or insufficient polyamic acid), the alkali agent uncomplexed with polyamic acid would affect the self-emulsification efficiency of polyamic acid, resulting in reducing the emulsion stability of the sizing agent and the thermal stability of the sizing layer consisting of the sizing agent. In addition, in the case of an insufficient alkali agent (or excess polyamic acid), less complex formed by the polyamic acid and the alkali agent would affect the self-emulsification efficiency of polyamic acid and subsequently reduce the thermal stability of the sizing layer consisting of the sizing agent.

Compared to polyamic acid alone, the complex formed by polyamic acid and the alkali agent exhibits better self-emulsification capability, making it easier to produce the water-based sizing agent. The water-based sizing agent, compared to the oil-based sizing agent, can reduce the formation of films caused by the removal of organic solvents at high temperatures during the processing of the carbon fiber. Thus, the sizing agent formed by the sizing agent composition of the present invention only requires a one-step heating process to coat the carbon fiber, effectively simplifying the process. In contrast, conventional oil-based sizing agent requires a multi-step heating process to reduce film formation.

Furthermore, compared to polyamic acid alone, the complex formed by polyamic acid and the alkali agent has lower polarity, resulting in better wettability of low-polarity carbon fiber, thereby enhancing the bonding strength of the sizing agent to the carbon fiber. In addition, the lower polarity of the complex of the present invention increases the compatibility of the sizing agent with the resin matrix, thereby enhancing the interlayer bonding strength of the composite materials produced from it.

Accordingly, in some embodiments, the sizing agent composition of the present invention does not require the addition of modifiers to enhance the wettability of carbon fiber. Conventional modifiers can include amino-silane compounds and polyphenylene ether compounds. In some embodiments, amino-silane compounds hinder the formation of stable complexes between the carboxyl groups of polyamic acid and the alkali agent.

In other embodiments, although polyphenylene ether compounds can generate π-π interactions with the aromatic rings of the resin matrix through their own benzene rings, polyphenylene ether compounds are insoluble in water. Therefore, additional surfactants need to be added to the sizing agent to help polyphenylene ether compounds dissolve in water to produce the water-based sizing agent. As a result, the thermal stability of the sizing layer consisting of the sizing agent including polyphenylene ether compounds is poorer.

Another aspect of the present invention is to provide a sizing agent. This sizing agent is formed by emulsifying the sizing agent composition described above. For example, the alkali agent and polyamic acid are firstly mixed, and then water is slowly added with vigorous stirring to allow polyamic acid to undergo self-emulsification. There is no specific limitation on the amount of water, and it can optionally be 70 to 90 times the total amount of polyamic acid and alkali used (by weight).

During the emulsification process, the carboxyl groups of polyamic acid form complexes with the amino groups, ammonium ions, or metal ions of the alkali agent, facilitating the self-emulsification of polyamic acid to obtain an aqueous polyamic acid emulsion. Subsequently, dilution water is added to obtain the sizing agent. The amount of dilution water can vary depending on the sizing rate and the method of sizing the carbon fiber, for example, 11 to 31 times the weight of the aqueous polyamic acid emulsion.

In some embodiments, the emulsification stability of polyamic acid can be evaluated based on the particle size and mobility rate of the sizing agent prepared with polyamic acid. Specifically, the particle size of the sizing agent can be less than 600 nm, preferably less than 350 nm, and even more preferably equal to or less than 280 nm. In addition, the mobility rate of the sizing agent can be less than 26.5% per hour.

Yet another aspect of the present invention is to provide a carbon fiber covered with the sizing agent. The carbon fiber covered with the sizing agent comprises a carbon fiber and a sizing agent layer covering the same. The sizing layer consists of the aforementioned sizing agent. In some embodiments, the sizing agent is impregnated onto the surface of the carbon fiber at the temperature of 290° C. to 300° C., followed by a baking process to remove solvents and form the sizing layer. For example, there are no specific limitations on the sizing agent in the sizing layer, which varies depending on the product requirements. The sizing rate of the sizing agent on the carbon fiber can be 0.1 weight percent to 5 weight percent, preferably from 0.5 weight percent to 3 weight percent, so as to enhance the interlayer bonding strength of the composite materials.

In some embodiments, the sizing layer formed by the sizing agent has a thermal weight loss of less than 1 weight percent after 30 minutes at 300° C. When the sizing layer has the aforementioned thermal weight loss, it exhibits good thermal stability, making the sizing agent suitable for processing carbon fiber at high temperature. Preferably, the thermal weight loss of the sizing layer is less than 0.4 weight percent, and preferably less than or equal to 0.30 weight percent.

Yet another aspect of the present invention is to provide a composite material. The composite material comprises a resin matrix, and the aforementioned carbon fiber covered with the sizing agent and distributed within the resin matrix. The resin matrix can include but be not limited to polysulfides, polyamides, and/or polyether ether ketones. In some embodiments, the composite material can be obtained by alternately stacking the resin matrix and the carbon fiber covered with the sizing agent followed by compression molding. The compression molding conditions depend upon the properties of the resin matrix, such as the softening point and thickness, and can be performed using any conditions commonly used in the relevant technical field of the present invention by those skilled in the art.

The following examples are provided to illustrate the applications of the present invention, but they are not intended to limit the scope of the invention. Those skilled in the art can make various modifications and refinements within the spirit and scope of the present invention.

### Synthesis of Polyamic Acid

### Synthesis Example 1

100 grams of pyromellitic dianhydride and 15 to 45 grams of N,N-dimethylformamide were heated under a nitrogen atmosphere, so as to melt the pyromellitic dianhydride. Then, 4,4′-diaminodiphenyl ether was added to the melted pyromellitic dianhydride to mix them. The reaction was carried out at 60 to 80° C. for 3 to 15 hours. During the reaction, the sample was taken from the reaction mixture, and the characteristic peak of carboxyl groups in the sample was detected using Fourier-transform infrared spectroscopy (FT-IR) (located at 1770 to 1860 cm-1). When this characteristic peak did not change, the reaction was determined to be complete, and polyamic acid was obtained.

### Synthesis Examples 2 to 4

Synthesis Examples 2 to 4 were performed using the same method as in Synthesis Example 1, but the difference in various types and various usages of dianhydrides and diamines. The specific conditions for Synthesis Examples 1 to 4 are shown in Table 1.

TABLE 1

| | | | Synthesis Examples | | | |
|---|---|---|---|---|---|---|
| | | | 1 | 2 | 3 | 4 |
| Polyamic | Dianhydride | ethylenediaminetetraacetic | — | — | — | — |
| acid | (usage, | dianhydride (EDTAD) | | | | |
| | weight | pyromellitic dianhydride (PMDA) | 100.0 | 100.0 | — | — |
| | percent) | 3,3′,4,4′-benzophenonetetra- | — | — | 100.0 | 100.0 |
| | | carboxylic dianhydride (BTDA) | | | | |
| | Diamine | 4,4′-diaminodiphenyl ether | 82.6 | 101.0 | 62.1 | — |
| | (usage, | (4,4′-ODA) | | | | |
| | weight | 1,6-hexanediamine | — | — | — | — |
| | percent) | 1,2-bis(2-aminoethoxy)ethane | — | — | — | 50.6 |

| | | | | |
|---|---|---|---|---|
| Molecular weight (g/mol) | 7700 | 7500 | 2340 | 10400 |

The symbol “—” represents that the ingredient is not in the Synthesis Example.

### Process of the Sizing Agent

### Example 1

During the stirring of the polyamic acid, the alkali agent was added, and deionized water, which was 70 to 90 times the total amount of polyamic acid and the alkali agent used, was slowly dripped in to obtain a water-based polyamic acid emulsion. Then, using a high-speed mixer at a speed of 4000 rpm to 10000 rpm, deionized water, which was 11 to 31 times the weight of the water-based polyamic acid emulsion, was dripped in over 3 hours to obtain the sizing material.

### Examples 2 to 9 and Comparative Examples 1 to 3

Examples 2 to 9 were performed using the same method as Example 1, but the difference in various kinds of usages of polyamic acid and the alkali agent. In addition, different sizing materials were compared between Examples 1 to 3, such as commercially available water-based epoxy sizing, commercially available polyamic acid solution, and commercially available polyphenylene ether solution. The specific conditions and evaluation results of Examples 1 to 9 and Comparative Examples 1 to 3 are shown in Tables 2 and 3, respectively.

### Evaluation Methods

### 1. Molecular Weight of Polyamic Acid

Using gel permeation chromatography (produced by Viscotek), columns (model numbers I-MBLMW-3078 and I-MBHMW-3078), and N-methyl-2-pyrrolidone (as the mobile phase), the molecular weight of polyamic acid (concentration of 0.5 to 1 weight percent) was measured at a flow rate of 0.8 milliliters per minute, with polystyrene used for calibration.

### 2. Particle Size of the Sizing Agent

The particle size of the sizing agent was measured using a particle size analyzer (manufactured by Brookhaven, model 90Plus/BI-MAS) to evaluate the emulsification effect of polymers (such as polyamic acid) included in the sizing agent. Smaller particle sizes indicated better emulsification effect and greater emulsion stability.

### 3. Mobility Rate of the Sizing Agent

The mobility rate of emulsion particles in the sizing agent (unit: %/hour) was calculated by measuring the changes in transmittance of the sizing agent using a stability analyzer (manufactured by LUM, model LUMiSizer 651). This measurement was used to assess the emulsion stability of the polymer (e.g., polyamic acid) included in the sizing agent. A slower mobility rate indicates better emulsion stability, resulting in a more stable sizing agent that can be stored for longer periods.

### 4. Thermal Weight Loss

The sizing agent was heated at 105° C. to 180° C. for several hours to remove moisture or solvent, forming a sizing layer. Subsequently, the thermal weight loss of the sizing layer was measured using a thermal analyzer (manufactured by Waters, model Q50) under a nitrogen environment at 300° C. for 30 minutes, with the initial weight of the sizing layer set at 100 weight percent. A lower thermal weight loss indicates better thermal stability of the sizing layer.

### Interlayer Shear Strength of the Composite Material

After applying the sizing agent to the surface of carbon fiber, the solvent of the sizing agent was dried, and then heated at 300° C. for 30 minutes to obtain carbon fiber coated with the sizing agent. Subsequently, the carbon fiber covered with the sizing agent were subjected to pre-impregnation treatment with resin matrix, followed by compression to form laminate sheets with a thickness of 3 mm, i.e., composite materials. The interlayer shear strength of the laminate sheets was measured according to standard method ASTM D-2344 to evaluate the interlayer bonding strength of the laminate sheets. Higher interlayer shear strength indicates stronger interlayer bonding strength, indicating that the sizing agent can enhance the bonding strength between carbon fiber and resin matrix. The resin matrix materials used were Nylon 6 (PA6) (manufactured by Taiwan Chemical Fiber Corporation, model PA2400), polyphenylene sulfide (PSS) (manufactured by Toray, model A670R63), and polyetheretherketone (PEEK) (manufactured by Victrex, model PEEK 450 PF).

TABLE 2

| | | | | Examples | | | | | |
|---|---|---|---|---|---|---|---|---|---|
| | | | | 1 | 2 | 3 | 4 | 5 | 6 |
| Composition | Polyamic acid | | items | Synthesis | Synthesis | Synthesis | Synthesis | Synthesis | Synthesis |
| | | | | Example 1 | Example 2 | Example 3 | Example 2 | Example 4 | Example 2 |
| | | | Usage | 100 | 100 | 100 | 100 | 100 | 100 |
| | | | (weight percent) | | | | | | |
| | Alkali (usage, | | triethylamine | 20.3 | 18.8 | 16.2 | — | 17.3 | — |
| | weight percent) | | tri-n-propylamine | — | — | — | 24.6 | — | — |
| | | | ammonia solution | — | — | — | — | — | — |
| | | | 1,8-diazabicyclo[5.4.0]undec-7-ene | — | — | — | — | — | 25.8 |
| | | | sodium bicarbonate | — | — | — | — | — | — |
| Evaluation | emulsion | | diameter (nm) | 310.0 | 73.0 | 265.0 | 259.6 | 172.0 | 420.0 |
| results | emulsion | | mobility rate (%/h) | 26.2 | 18.2 | 24.3 | 24.3 | 22.2 | 28.0 |
| | sizing agent | | thermal weight loss at 300° C. | 0.08 | 0.18 | 0.20 | 0.26 | 0.05 | 0.26 |
| | | | over 30 minutes (weight percent) | | | | | | |
| | composite | Interlayer | Polyphenylene Sulfide (PSS) | 24.7 | 21.2 | 23.2 | 25.5 | 18.9 | 16.2 |
| | material | Shear | Nylon 6 | 30.5 | 33.2 | 36.8 | 32.3 | 35.9 | 35.2 |
| | | Strength | Polyetheretherketone (PEEK) | 27.3 | 25.3 | 33.2 | 26.3 | 24.8 | 21.9 |
| | | (kgf/mm²) | | | | | | | |

The symbol “—” represents that the ingredient is not in the Example.

TABLE 3

| | | | | Examples | | | Comparative Examples | | |
|---|---|---|---|---|---|---|---|---|---|
| | | | | 7 | 8 | 9 | 1 | 2 | 3 |
| Composition | Polyamic acid | | items | Synthesis | Synthesis | Synthesis | — | — | — |
| | | | | Example 4 | Example 4 | Example 4 | | | |
| | | | Usage (weight percent) | 100 | 100 | 100 | — | — | — |
| | Alkali (usage, | | triethylamine | — | — | — | — | — | — |
| | weight percent) | | tri-n-propylamine | — | — | — | — | — | — |
| | | | ammonia solution | 6.7 | — | — | — | — | — |
| | | | 1,8-diazabicyclo[5.4.0]undec-7-ene | — | — | 9.8 | — | — | — |
| | | | sodium bicarbonate | — | 14.8 | — | — | — | — |
| | Commercially available water-based epoxy sizing agent | | | — | — | — | 100.0 | 100.0 | — |
| | (usage, weight percent) | | | | | | | | |
| | Commercially available polyamic acid solutions | | | — | — | — | — | — | 100.0 |
| | (usage, weight percent) | | | | | | | | |
| | Commercially available polyphenylene ether solution | | | — | — | — | — | — | 66.0 |
| | (usage, weight percent) | | | | | | | | |
| Evaluation | emulsion | | diameter (nm) | 454.0 | 421.0 | 350.0 | 850.0 | 665.0 | 350.0 |
| results | emulsion | | mobility rate (%/h) | 29.5 | 29.5 | 27.2 | NA | NA | 60.0 |
| | sizing agent | | thermal weight loss at 300° C. | 0.75 | 0.95 | 0.13 | 5.60 | 1.84 | 0.41 |
| | | | over 30 minutes (weight percent) | | | | | | |
| | composite | Interlayer | Polyphenylene Sulfide (PSS) | 20.2 | 18.2 | 18.3 | 11.7 | 10.3 | NA |
| | material | Shear | Nylon 6 | 30.5 | 29.8 | 36.8 | 16.4 | 19.3 | NA |
| | | Strength | Polyetheretherketone (PEEK) | 22.6 | 25.0 | 24.6 | 15.0 | 19.3 | 20.4 |
| | | (kgf/mm²) | | | | | | | |

The symbol “—” represents that the ingredient is not in the Example.
“NA” represents that the test is not available.
Commercially available water-based epoxy sizing agent includes 15 to 20 weight percent of nonionic surfactant.

Please referred to Tables 1 to 3. Compared to Comparative Examples 1 and 2 using water-based epoxy sizing agents, Examples 1 to 9 used polyamic acid with a molecular weight of 5000 to 30000 grams per mole and specific types of the alkali agent, thereby improving the emulsification stability of polyamic acid and the thermal stability of the sizing layer in the sizing agent composition, thereby enhancing the bonding strength between the carbon fiber and the resin matrix in the composite material.

Next, please referred to Table 2. Compared to Examples 6 to 9, Examples 1 to 5 used organic amine compounds with molecular weights of 31 to 150 grams per mole, thereby providing polyamic acid with better emulsification stability and the sizing layer with better thermal stability, further enhancing the bonding strength between the carbon fiber and the resin matrix in the composite material.

Please also referred to Tables 2 and 3. Compared to Examples 1 to 9 without using polyphenylene ether compounds (as modifiers) and nonionic surfactants, Comparative Example 3 additionally used nonionic surfactants and polyphenylene ether compounds to improve the emulsification effect of the sizing agent (such as reducing its particle size) and the thermal stability of the sizing layer formed thereby. However, compared to Examples 1 to 9, the mobility rate of the polyamic acid prepared in Comparative Example 3 was still higher, and the interlayer shear strength of the resulting composite material was still weaker.

In summary, the sizing agent composition of the present invention comprises polyamic acid and the alkali agent. The alkali agent has a specific molecular weight, and the molar ratio of the alkali agent to the polyamic acid is in a specific ratio, thereby enhancing the emulsification stability of the polyamic acid and the thermal stability of the sizing layer formed by the sizing agent composition, thereby strengthening the interlayer bonding strength of the composite material obtained by the carbon fiber covered with the sizing agent.

It should be noted that the above-mentioned alkali agent can also use salts of organic amine compounds (such as hydrochloride, nitrate, acetate, etc.) to obtain sizing agent compositions with similar properties.

Although the present invention has been disclosed in the embodiments as described above, it is not intended to limit the present invention. Those skilled in the art within the technical field of the present invention can make various modifications and improvements without departing from the spirit and scope of the present invention, and therefore, the protection scope of the present invention should be determined by the appended claims of the patent application.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A sizing agent composition, comprising:
polyamic acid;
an alkali agent, wherein a molecular weight of the alkali agent is greater than 31 g/mol and less than 170 g/mol, and a molar ratio of the alkali agent to the polyamic acid is from 0.01 to 0.2; and
a solvent,
wherein based on 100 parts by weight of the polyamic acid, the alkali agent is 3 to 30 parts by weight.

2. The sizing agent composition according to claim 1, wherein a molecular weight of the polyamic acid is from 5000 g/mol to 30000 g/mol.

3. The sizing agent composition according to claim 1, wherein the alkali agent is selected from the group consisting of organic amine compounds, salts of the organic amine compounds, ammonia solution, alkali metal bicarbonates, and any combination thereof.

4. The sizing agent composition according to claim 3, wherein the organic amine compound is a tertiary amine compound having 3 to 9 carbon atoms.

5. The sizing agent composition according to claim 1, wherein the polyamic acid has the following chemical structure represented by formula (I): 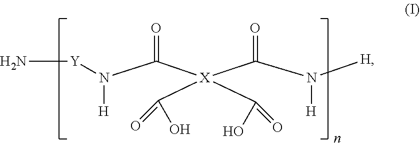
In the formula (I), X represents a tetravalent group having the chemical structures shown in formulas (I-1-1) to (I-1-5), Y represents a divalent group having the chemical structures shown in formulas (I-2-1) to (I-2-4), and n is an integer from 7 to 62; 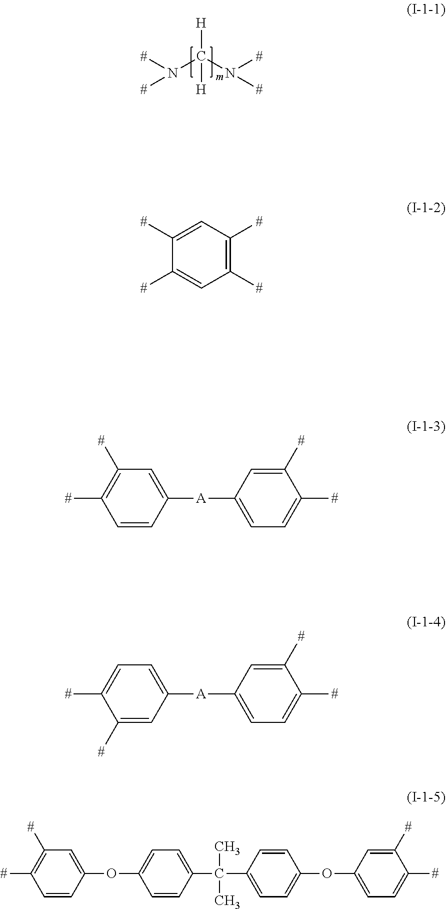
in the formulas (I-1-1) to (I-1-5), these symbols # represent the position where X is bonded to the carbon atom of the amide or carboxyl group shown in the formula (I); in the formula (I-1-1), m represents an integer of 1 to 4; in the formulas (I-1-3) to (I-1-4), A represents a bond, ether group, ketone group or sulfone group; 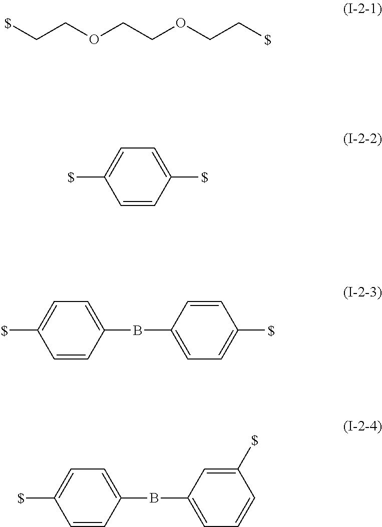
in the formulas (I-2-1) to (I-2-4), the symbols $ represent the position where the Y is bonded to the nitrogen atom of the amide or amine group shown in the formula (I); in the formulas (I-2-3) to (I-2-4), the B represents an alkylene group, an ether group, a thioether group or a sulfone group with 1 to 3 carbon atoms.

6. The sizing agent composition according to claim 1, wherein a molar ratio of the alkali agent to the polyamic acid is from 0.02 to 0.15.

7. A sizing agent comprising the sizing agent composition according to claim 1.

8. A carbon fiber covered with a sizing agent, comprising:
a carbon fiber; and
a sizing layer covering the carbon fiber, wherein the sizing layer consists of the sizing agent composition according to claim 7, and the sizing layer has a thermal weight loss of less than 1 weight percent at 300° C. for 30 minutes.

9. A composite material, comprising:
a resin matrix; and
carbon fiber covered with the sizing agent according to claim 8, wherein the carbon fiber covered with the sizing agent is distributed in the resin matrix.

10. The composite material according to claim 9, wherein the resin matrix comprises polyphenylene sulfide, polyamic acid, and/or polyetheretherketone.

11. A sizing agent composition, comprising:
polyamic acid, wherein the polyamic acid is synthesized by a dianhydride and a diamine, the dianhydride comprises 3,3′,4,4′-benzophenonetetracarboxylic dianhydride (BTDA), the diamine comprises 4,4′-diaminodiphenyl ether (4,4′-ODA) or 1,2-bis(2-aminoethoxy) ethane, and a molecular weight of the polyamic acid is from 5000 g/mol to 30000 g/mol;
an alkali agent, wherein a molecular weight of the alkali agent is greater than 31 g/mol and less than 170 g/mol, and a molar ratio of the alkali agent to the polyamic acid is from 0.01 to 0.2; and
a solvent,
wherein based on 100 parts by weight of the polyamic acid, the alkali agent is 3 to 30 parts by weight.

12. A sizing agent comprising the sizing agent composition according to claim 11.

13. A composite material, comprising:
a resin matrix; and
a carbon fiber covered with a sizing agent, wherein the carbon fiber covered with the sizing agent is distributed in the resin matrix, the sizing agent comprises a sizing agent composition, the sizing agent composition comprises:
polyamic acid, wherein the polyamic acid is synthesized by a dianhydride and a diamine, the dianhydride comprises 3,3′,4,4′-benzophenonetetracarboxylic dianhydride (BTDA), the diamine comprises 4,4′-diaminodiphenyl ether (4,4′-ODA) or 1,2-bis(2-aminoethoxy) ethane, a molecular weight of the polyamic acid is from 5000 g/mol to 30000 g/mol;
an alkali agent, wherein a molecular weight of the alkali agent is greater than 31 g/mol and less than 170 g/mol, and a molar ratio of the alkali agent to the polyamic acid is from 0.01 to 0.2; and
a solvent,
wherein based on 100 parts by weight of the polyamic acid, the alkali agent is 3 to 30 parts by weight.

14. The composite material according to claim 13, wherein the sizing layer has a thermal weight loss of less than 0.4 weight percent at 300° C. for 30 minutes.

15. The composite material according to claim 13, wherein the sizing layer has a thermal weight loss of less than 0.3 weight percent at 300° C. for 30 minutes.
